(19) United States
(12) Patent Application Publication
(10) Pub. No.: US 2018/0365676 A1
(43) Pub. Date: Dec. 20, 2018

(54) ONLINE TRANSACTION PROCESSOR TO ENABLE LOCATION-BASED RESTRICTED DEVICE USAGE

(71) Applicant: PAYPAL, INC., San Jose, CA (US)

(72) Inventor: Todd Murray Studnicka, Omaha, NE (US)

(21) Appl. No.: 15/623,276

(22) Filed: Jun. 14, 2017

(51) Int. Cl. G06Q 20/30; H04W 4/02; G06Q 30/06; B64C 39/02; G08G 5/00

(52) U.S. Cl. CPC G06Q 20/30; H04W 4/021; G01S 19/42; B64C 39/024; G08G 5/006; G06Q 30/0601

(57) ABSTRACT

There are provided systems and methods for an online transaction processor to enable location-based restricted device usage. A user may wish to utilize a device within a restricted area where device operations are restricted or banned without authorization and permission from a controlling entity. The user may generate a request for usage right within the area, and communicate the request to a service provider. In further embodiments, the user may utilize the device to enter another transaction within the area, including a transaction with another entity in the area, such as a merchant. The service provider may then determine a transaction within the area, for example, for the usage rights, and communicate the transaction to the user. If the user approves the transaction, the user may be granted rights to use the vehicle in the area or the service provider may process the transaction with the entity.

### TECHNICAL FIELD

The present application generally relates to device usage and operations within restricted areas and more specifically to managing location-based restricted device usage and operations.

### BACKGROUND

Certain geographic areas may have use restrictions associated with the areas, for example, to prevent a device from operating or limit functionality of a device within the area. In particular, an unmanned device, such as unmanned aerial vehicles (UAVs) or drones, may be limited from use in particular geographic areas to prevent damage, disturbance, or hazardous operating conditions. In certain embodiments, the restrictions may prevent all usage, or the restrictions may limit certain specific usages, including media capture. The administrators or owners of such locations may enforce these restrictions on all devices entering the area, but may also provide permissions and rights to specific users. However, in order to receive rights to utilize the devices within the restricted areas, the processes for operators of the devices may be lengthy and convoluted. Moreover, the entity controlling the areas may not be able to detect restricted device usage or control how a device is used within an area, and assess penalties against the party utilizing the device without authorization.

### BRIEF DESCRIPTION OF THE DRAWINGS

FIG. 1 is a block diagram of a networked system suitable for implementing the processes described herein, according to an embodiment;

FIG. 2 is an exemplary environment having an unmanned vehicle operating in a location having usage restrictions and a mobile device to enable restricted device usage at the location, according to an embodiment;

FIG. 3 is an exemplary system environment showing a communication device and a service provider server interacting to provide an online transaction processor to enable location-based restricted device usage, according to an embodiment;

FIG. 4 is an exemplary interface of a communication device used to view available media content captured for locations and process transactions with merchants identified at a location, according to an embodiment;

FIG. 5 is a flowchart of an exemplary process for an online transaction processor to enable location-based restricted device usage, according to an embodiment; and

FIG. 6 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an online transaction processor to enable location-based restricted device usage. Systems suitable for practicing methods of the present disclosure are also provided.

According to various embodiments, a user may utilize a device at a location that has restrictions on device usage at the location. For example, the location may not allow unmanned aerial vehicles (UAVs) to fly within the location or in proximity to the location, or may not allow the device to capture media data and other content (e.g., videos and/or images). In order to utilize the device and not receive penalties on usage at the location, the user may interact with a service provider, such as an online transaction processor, that may provide transaction processing services to receive usage rights for the device within the location. The service provider may receive a request to receive the usage rights, or may detect a location of the device as matching (e.g., at or within a set proximity to) the location. Based on the location of the device, the service provider may then determine transaction information necessary for the device and/or user to receive the usage rights, and may communicate transaction information and/or usage rights information to the user. Once processed, the service provider may further update an entity administering or controlling the location with information indicating that the device is authorized for use at the location, including what type(s) of authorized use. In other embodiments, the request by the device at the location may be associated with a merchant or other seller at the location, where the request may be to purchase goods or services (referred to herein as an item or items) from the seller at the location.

Thus, a user may utilize a device, including unmanned vehicles (e.g., UAVs or drones), media capture devices, mobile electronic devices (e.g., mobile phones or other communication devices), and/or other types of computing devices, at or in proximity to a restricted location. The unmanned vehicle may also correspond to a driverless car, which may require permission to access locations, including toll roads, bridges, restricted land, or requiring services including parking or valet parking. In various embodiments, the user's device may be associated with another of the aforementioned devices, such as a communication device or mobile phone used to control an unmanned vehicle. The location may correspond to an area where device usage is prevented, restricted, or otherwise limited over, within, or in proximity to the area. For example, the area may correspond to a park, commercial building or zone, or other type of areas that entities controlling or owning the area may wish to limit the device usage, including secure areas that may require security clearance for use. The location may include geo-fencing or other geographic borders for the area having the restrictions, which may be established by the controlling entity with a service provider, as discussed herein. The geo-fencing may be established with one or more computing devices, including servers of the service provider and accessible by the devices at or nearby the location or other devices (e.g., operating devices for a UAV) so that the devices may be able to process location data and geo-fencing data to determine when the device is within or in proximity to the location having restricted usage. A UAV or other device may provide the location data of the UAV/device to a service provider for processing, as well as a user so that the user may view and/or designate areas of avoidance for the UAV/device. However, in other embodiments, the device may operate at a location or an area that does not have restricted device usage, or may operate within the requirements for the restricted device usage, and instead the device or user associated with the device (e.g., the device's operator) may request a transaction at the location, for example, from one or more merchants at or nearby the location that are identified by the device or the service provider. Thus, the service provider may assist the controlling entity for the location with establishing the area of the location, as well as the restrictions on use at or in proximity to the location and transaction processing for device usage permissions at the location.

The controlling entity for a location may establish the location as having one or more restrictions with a service provider. The restrictions may include one or more restrictions or limitations on device usage, which may limit all device presence or usage in or nearby the location, or specific processes or functions of devices in or nearby the location. For example, a restriction on a UAV at a national park may prevent UAV flight within or nearby the park to protect environmental factors within the park. Similarly, a restriction on land owned by another may limit photography or video capture to maintain privacy, while commercial or governmental locations may limit media data capture to insure confidentiality and/or security. Thus, the controlling entity for a location may establish the restriction to prevent a device, or processes of the device, from being used at or nearby the location. The restrictions may also be user and/or device specific, for example, by limiting certain user's device usage or certain devices or types of devices while allowing other users/devices. Such restrictions may be based on security clearances, jobs or processes performed by the user/device, day, time, or other condition or status.

Restriction may further correspond to enforced limitations on device usage at the area, and may be associated with computer code, processes, and/or applications used to enforce the restriction on the particular device. In this regard, the restriction may be generated by the controlling entity for the area, and provided to the service provider for enforcement. In other embodiments, the restriction parameters or requirements may be selected by the controlling entity and/or provided to the service provider for generation by the service provider. The service provider may therefore receive data for restriction requirements and enforcement of a selected area for a location, which may then be used by the service provider to determine whether a device is associated with a location (e.g., within the location or a set proximity to the location), and whether the device requires permission to operate and/or perform one or more processes within the location. In other embodiments, another processing entity, including the controlling entity, may instead include the computing devices, services, and/or processes to establish restrictions on device use for an area. Thus, another entity may provide the processes and/or features discussed herein with regard to the service provider. In certain embodiments, the service provider may provide the computing infrastructure, including networked servers, software development kits, and/or applications to perform the structures discussed herein. Thus, the controlling entity may utilize such components to provide restriction services, enforcement, and/or purchase of usage rights without the use of the service provider. The controlling entity may also establish such components, services, and processes discussed within without the use and/or requirement of the service provider.

The restrictions may also be associated with code, processes, and/or applications to determine a device is at (or approaching) a location and/or detect device usage at (or nearby/associated with) the location, for example, through device detection at or near the location and/or data communication exchanges between the device and the service provider. In various embodiments, location detection of the device at or near the location may be performed using a global position system (GPS) of the device, including an onboard GPS system of a UAV used for positioning and/or control (e.g., flight) of the UAV. The GPS may also be included with other communication devices, such as a mobile phone, to determine whether the communication devices are at or near the location. Other location detection systems and/or application may be used, including mapping applications for communication devices and/or operation applications for an unmanned vehicle that may be used to navigate the vehicle and/or see the vehicle's location on a map of the local area of the vehicle. A UAV may transmit position information that includes a longitude coordinate, a latitude coordinate, and an altitude coordinate associated with the UAV. The altitude coordinate may be a distance (e.g., height) from a reference sea level. In some cases, rather than the longitude, latitude, and/or altitude coordinates, other coordinate systems by which to define the position of the UAV may also or alternatively be received.

In certain embodiments, media data (e.g., images, audio, and/or video) captured by the device (e.g., through a camera and/or other sensor of a communication device or unmanned vehicle) may be received by the service provider during operation of the device. The media data may be utilized to identify a location of the device and/or device operations of the device. For example, the service provider may identify landmarks and/or a location through the media data to identify the location. The media data may also be utilized to identify other merchants and/or sellers at the location, as discussed further herein. In further embodiments, the location detection and/or data exchanges at the location may be facilitated by one or more devices at the location for the service provider and/or controlling entity. For example, a device at the location may transmit radio signals or other communications, which may be received by devices and/or used to detect the device at the location. The communications may include requests for operating conditions, available devices, and/or device usage at the location, which may be transmitted back to the device or service provider. The devices at the location may also use additional processes to determine whether a device is at the location and/or the operations of the device at the location, for example, through signal detection of the device (e.g., based on detected network communications or other signal emitted by the device).

Once the device is determined to be associated with the location, the service provider may determine information required to provide usage rights and/or permissions to use a device in general or for a particular purpose at the location. A restriction may also be associated with permissions or usage rights for devices at or nearby the location, which may provide use of the device at the location without violating or incurring a penalty based on the restriction. In this regard, a usage right or permission may correspond to code, processes, and/or applications available to the service provider to allow use of the device at the location over the restriction placed on devices at the location. The usage right may provide access or permission of use at multiple restricted locations, as well as limit the usage right within particular limited areas at the restricted area, such as a sub-area or zone within the restricted area for the location. For example, a usage right may allow flight or landing of a UAV at the location, package delivery by the UAV, or may allow a device to capture media data at the location. The usage right may authorize the device for use so that the user and/or device may not be penalized for use at the location based on the restriction. The usage right may be associated with a cost or price of purchase for the usage right, which may correspond to a value amount required from the user to receive the usage right and allow use of the device at the location. The controlling entity and/or service provider may set the cost for the usage right, which may correspond to a general permission for use of the device (or device process), a limited time use of the device (or device process) at the location, and/or a limited number of uses of the device (or device process) at the location. For example, the controlling entity may require $20 to allow use and access of the device at the location, $5 for media capture rights, and/or $1 for data communications. Each available right and cost may further be limited by a number of times at the location and/or a limited amount of time, such as a day. Additionally, the cost or purchase value of a usage right may be dependent on additional factors, including air/ground traffic at a location, a number of users at the location, a time of day, an event occurring at the location (e.g., a concert or festival that may qualify as a special occurrence at the location), or other factor. Thus, the cost for a usage right may increase or decrease dependent on factors associated with the location.

The user may request a specific transaction for a usage right when the device approaches or is at the location. For example, a device operating an unmanned vehicle, such as a flight controller or other communication device, may receive notification that the unmanned vehicle is approaching or within a restricted location for usage. The notification may be provided based on a map of the location and known restricted location, which may be provided by the service provider to one or more mapping and/or operation applications for devices. In other embodiments, additional devices at or nearby the location may transmit locally receivable signals (e.g., using a local area network or wide area network wireless signal) to the unmanned vehicle or other device of the location restriction, which may be populated into an interface associated with the device to alert the user. Moreover, the user may directly be informed of restricted usage at a location through posted signage, a person, or other available information at the location, which may include information necessary to access the service provider and request a transaction for the usage rights. The request may include at least the location of the device, and may further include the requested usage right, such as general device usage, media capture rights, etc.

Based on the location of the device, the service provider may determine transaction information for a device to receive the usage right or permission for conducting a transaction. The transaction information may include one or more purchasable usage rights, as well as one or more costs for the usage right, which may depend on the duration or amount of the usage right for purchase. The transaction information may be determined using the usage rights and permissions information for the restriction on device usage at the location, and may be retrievable by the service provider from the controlling entity and/or stored with the service provider. Using the transaction information, data for one or more transactions may be generated by the service provider, which may be transmitted to the device in response to the request for the usage right. In other embodiments, the device may be provided with the transaction data for one or more transactions for the usage rights based on approaching or being located at the location. The transaction data may be transmitted by the service provider based on the location of the device, or by one or more devices at the location that transmit local signals. Such transaction data may then be used by the user to initiate and process a transaction to receive the usage right and allow general or specific device usage at the location.

In other embodiments, a request for processing a transaction at a location may correspond to a request to process a transaction with a seller or merchant at the location. In order to initiate the request, the device at or near the location may identify at least the location of the device. The service provider may determine the merchant from the location (e.g., through GPS coordinates), or may provide multiple merchant identifications to the user's device for selection by the user. The request may include items for purchase by the user, or may request information from the merchant for selection of an item for purchase, such as a menu or list of items available from one or more merchants. The service provider may also receive media data captured by the user's device or an unmanned vehicle that may be used to identify a merchant at a location, for example, an image of the merchant. In such embodiments, object or other image recognition processes may be used to determine the merchant, and access merchant information for a transaction request. In response to the request, the service provider may send data to the user's device to allow for generation of a purchase request for one or more items from the merchant identified for the location. In embodiments where the merchant and items for the transaction are determinable from the request, the service provider may request only authorization of the transaction from the user's device.

In various embodiments, the service provider may further determine additional or alternative purchases at the areas that are available for the device. The additional purchases may correspond to the device requesting use or permission for use within the area, and may provide processes or features to the device. For example, a purchase for an unmanned vehicle within an area may correspond to a travel or flight path in the area determined by the controlling entity or another user, which may provide a common path or path to travel to or view specific or desired geographic features at the area. In certain embodiments, the purchases may correspond to information used for the device at the location, for example, waypoints or a map to view certain features, directions or times to view or capture media data, or other types of information. The additional purchases may also correspond to data other users have generated at or for the location, including media content captured by other users at the same or different times, specific device uses of interest at the location, or other data, which may be available on an online marketplace, as discussed further herein. The additional purchases may be determined from received or online data for the location, including an online marketplace of data uploaded by other users. Where the user has requested to purchase from a merchant or seller at a location, the additional purchases may correspond to other items for sale from the merchant, commonly sold items, and/or user purchases of interest for the merchant or other nearby merchants at the location. Such information may be determined from available merchant data or other accessible data.

Thus, after transmission of the transaction data to the device, the service provider may receive a processing request for a transaction for one or more usage rights, as well as one or more additional purchases in certain embodiments. The processing request may include information identifying the requested purchase, such as one or more usage rights, as well as information necessary to process the transaction. The information necessary to process the transaction may include a payment instrument selected by the user, or other data necessary to identify a payment instrument, such as an account token or other data identifying an account with the service provider. Thus, the purchase request may include tokenized data from the user's device used for electronic transaction processing using an account.

In order to process a transaction, the user may engage in electronic transaction processing with the merchant, seller, or controlling entity providing the item in the transaction (e.g., the transaction for the usage right or additional purchase). The service provider may provide transaction processing services that may allow two or more entities (e.g., personal users, groups of users, merchants, etc.) to engage in electronic processing for a transaction, including a purchase of goods and/or services from two or more users, merchants, or other entities. The service provider may further provide additional types of services, including account services and digital wallet service, for example, to store one or more financial instruments of the user for use in transaction processing and provide a digital wallet that may be utilized to perform transaction processing through tokenized payment services.

Thus, the user and/or the merchant may further be required to establish an account with the service provider in order to engage in transaction processing. The user may be required to provide personal, business, or other identification information to establish an account, such as a name, address, or other identification information. The user may also be required to provide financial information, including payment cards (e.g., credit/debit cards), bank account information, gift cards, and/or benefits/incentives, which may be utilized to provide payments or otherwise engage in processing of another transaction. In order to create an account, the user may be required to select an account name and/or provide authentication credentials, such as a password, personal identification number (PIN), security questions, biometric, and/or other authentication information. The service provider may utilize such information to create the account for the user, and provide the user with a digital wallet to the user that allows for electronic transaction processing in the restricted area. The digital wallet may store the user's financial instruments of the user and allow the user to process transactions through the digital wallet. In this regard, the service provider may provide a digital token, such as a data package, that represents the digital wallet and may approve the digital wallet for processing of a transaction with the service provider to a device that receives the token. Thus, the token may include data identifying the digital wallet (e.g., a token), as well as authentication information including an identifier for user of the digital wallet, which may be encrypted.

Once an account is created, the account may be accessed through a web browser from a website of the service provider and/or a dedicated application of the service provider, such as a mobile smart phone application. The user may engage in transaction processing through accessing their respective account and providing transaction information for the transaction. Thus, the aforementioned token may be issued to the user for their account, where the token may include data (which may be encrypted) allowing the service provider to identify the user and their account, as well as authenticate the user. As such, the token may be transmitted to other entities during transaction processing, which may allow the service to identify and authenticate the user's account and engage in transaction processing. Thus, the accounts may store information associated with each user, merchant, or other entity for use in transaction processing.

In this regard, a computing device for a user, such as a communication device or mobile smart phone of a user, may further include a mobile payment application or more generally a transaction processing application, which may be configured to send and receive payments to another party, such as another user, the controlling entity for a location, and/or a merchant at the location, or otherwise engage in transaction processing. In various embodiments, a website may provide the transaction processing services, and thus may be accessed by a web browser application. The application (or website) may be associated with a payment provider, such as PayPal® or other online payment provider service, which may provide payments and the other aforementioned transaction processing services on behalf of user, merchants, and other entities. The application may execute on the computing device for a user, and may provide various functionalities and processes to the user. For example, a user may utilize the application to send and/or receive payments between the user and another user/merchant/entity for one or more items purchased in a transaction. A merchant or other seller may similarly send and/or receive payments between the merchant and another user/merchant, which may include receiving payment for transactions.

The service provider may therefore process the transaction for the usage rights or purchases based on the received transaction request and the identified purchase. Once processed, the device of the user may be authorized for use at the location based on the usage right received. Where an item is purchased, the item may be purchased from the corresponding merchant/seller and provided to the user or the user device. The user may provide delivery information using the device for physical item purchases, or may be provided with pickup instruction. On purchase of a usage right, the controlling entity may be informed of the purchase, and may authorize the user's device for use at the location. Thus, the controlling entity may then permit device usage in accordance with the purchased usage right at the location. This may unlock the device to be used at the location, allow a function of the device to be used at the location, and/or prevent penalties from be imposed on the user or device for detected unauthorized use at the location. Additionally, after receiving the usage right, the user may utilize the device more or less than the purchased usage right. For example, a user may wish to capture additional images over the number or length of right allowed by the purchased usage right. Thus, the service provider may alert the user when the usage right is running out or low and the user may be provided a notification and process to purchase additional rights. If the user does not use the full extent of the usage right, the service provider may also provide a credit or refund for the amount of unused right.

Once the user's device is authorized for use at the location, the controlling entity may be informed to prevent penalties on the use of the user's device or to the user based on the device usage, prevented from applying penalties to the user or user's device, and/or removing restrictions, such as signal jamming, to enable the device to perform the authorized use. The usage right may only be valid for the scope of the usage right, so that if the user utilizes the device without a corresponding usage right and in violation of a restriction, the user may be penalized for the device usage. Moreover, if the user does not purchase the usage right, the user may be further penalized if the user utilizes the device at the location in violation of a restriction. Thus, in various embodiments, the service provider (or the other processing entity controlling the location) may further include processes and/or applications to determine whether a device is operating without a usage right and/or permission at the location in violation of an established restriction. For example, unmanned vehicle or UAV movement, presence, and/or flight may be detected through one or more cameras, radio signals, radar, or user input. Other device usages, include media capture may be detected through detecting the presence of the media capture device, a process of the media capture device, such as a shutter activation, hand motion by a user, device presence and directionality (e.g., aiming), and/or a flash of the device. The media capture process may also be detected through querying devices for executed processes over a communication link with the device, or through detecting whether the device has uploaded media data to one or more online resource (e.g., a cloud computing architecture to store and/or provide media data, etc.), and/or the content of the uploaded media data. Thus, in some cases, the restricted device usage may be determined after the device usage that violates the restriction.

The processes and/or applications of the service provider may further enforce restrictions on the device, for example, by limiting or restriction operations of the device for the location and/or alerting an enforcement entity of the device operations at the location. Such enforcement may correspond to code, processes, and/or applications that directly prevent particular device usages, as well as through posted or available information alerting users of the restrictions. The controlling entity may determine and enforce the penalties, or the penalties may be determined and/or enforced by the service provider through detecting the device usage and billing or deducting a cost or value from the user's account with the service provider. Such a penalty may be performed automatically if the user utilizes their device at the area without authorization. The penalty may be assessed at the time of the device usage that is restricted or may be assessed after determining that the device usage has occurred (e.g., when determining that an online resource has media data captured without a usage right). Moreover, the user may be provided with a grace period to request the usage right, for example, where the user is initially unaware of the restriction. Moreover, where the restriction is enforced on the device, after leaving a location or restricted geo-fenced area, the restrictions on device usage may be lifted and the device may be enabled to continue normal operations without the restriction.

In various embodiments, the usage right and associated cost may correspond to a right to upload media data and/or provide the media data on a marketplace or viewing service website for viewing/purchase by other users. The right to upload media may be a general right for captured media, or may correspond to an amount of uploaded media (e.g., file size, duration, consumed bandwidth, number of files, etc.). The user may upload the media data to one or more online repositories, including publicly available online resources, such as media sharing services, social networking platforms, etc. The cost for upload rights may be online resource dependent, for example, a different cost depending on the online platform that the data is uploaded to. The device may also allow for transmission of data between other devices at or nearby the location, for example, where one UAV connects and communicates with a second UAV. The devices may share media data to provide media data to other devices for use and storage, as well as prevent duplicate data capture and collection. In further embodiments, the user may upload the media data to an online marketplace or online platform, including a media streaming service, which allows for sharing of the media content with other users. Other users may therefore access the online service and view media content from other users. In certain embodiments, user may purchase rights to the media content, for example, to share, download, and/or view, as well as subscribe to certain media uploads or streams, including user specific media channels or streams. Moreover, users may also be provided with location-specific media content uploaded to the online service from other users based on detected locations for the user. For example, by knowing a current location (e.g., GPS coordinates) or a location of interest, the online marketplace may provide one or more past captured data uploads or current media data stream to the user.

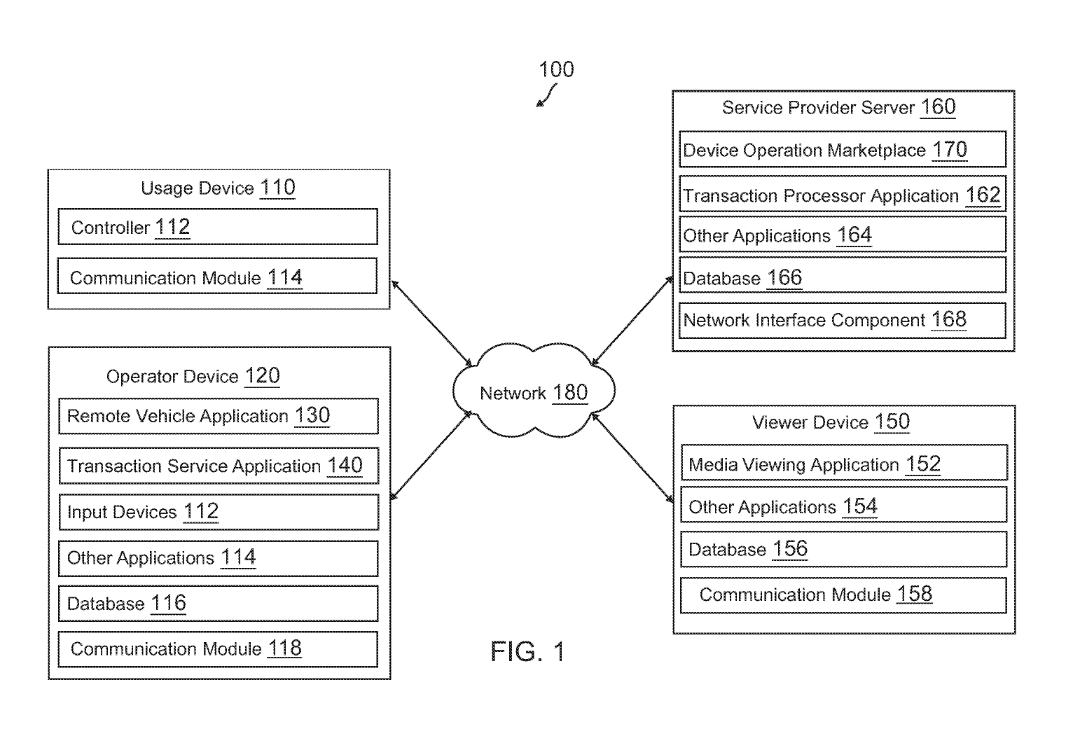

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a usage device 110, an operator device 120, a viewer device 150, and a service provider server 160 in communication over a network 180. A user (not shown) may utilize operator device 120 to utilize the various features available for operator device 120, which may include processes and/or applications associated with usage device 110 and/or operator device 120 that utilize the device at a location having restrictions on device usage. The user may request or receive notifications of required usage rights to utilize usage device 110 and/or operator device 120 at the location, which may be determined by service provider server 160 using one or more set restrictions and/or usage rights for the location. Service provider server 160 may be used to process a transaction to receive the usage rights, as well as institute penalties for device usage without the rights at the location. Additionally, media data may be uploaded to service provider server 160 for viewing or other consumption by another user using viewer device 150. In various embodiments, a merchant device may also be included for interacting directly with a merchant and/or controlling entity that provides usage rights as well as other purchases for a location having one or more restrictions on device usage.

Usage device 110, operator device 120, viewer device 150, and service provider server 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 180.

Usage device 110 may correspond to a UAV or other unmanned vehicle, or may more generally correspond to a device that may be remotely controlled by operator device 120, and may be utilized at or nearby a location that has restrictions on device usage. Usage device 110 includes a controller 112 and a communication module 114, which may be used at a location to perform one or more processes. For example, where usage device 110 corresponds to a UAV or other remote vehicle, controller 112 may include a flight or operation control unit. The control unit or other operation module of usage device 110 may be configured to facilitate navigation of usage device 110, e.g., take off, landing, navigation, driving, and/or flight of usage device 110. Such an operation module may include any appropriate avionics, control actuators, and/or other equipment, along with associated logic, circuitry, interfaces, memory, and/or code. The operation module may include one or more appropriate components for use of features and equipment provided by a payload unit of usage device 110, including camera controllers, GPS location services, and the like. Additionally, the control unit or other operation module may include a controller that receives flight route information from one or more sources, including a memory and/or external controller (e.g., set instructions from a service provider and/or inflight navigation/instructions from an operator) that operates usage device 110. Further, a separate battery may be provided for control, so that usage device 110 may be able to communicate with an entity, in the case of main system power failure or other types of issues during operation and flight of usage device 110.

Communication module 114 may include one or more radio transceivers (e.g., that include antennas) along with associated logic, circuitry, interfaces, memory, and/or code that enable communications, via wireless interfaces and using the radio transceivers. In FIG. 1, the radio transceivers of usage device 110 include an antenna that may include suitable logic, circuitry, interfaces, memory, and/or code that enable wired communications. In this regard, usage device 110 may be configured to interface with a wired network, such as via an Ethernet interface, power-line modem, Digital Subscriber Line (DSL) modem, Public Switched Telephone Network (PSTN) modem, cable modem, and/or other appropriate components for wired communication. A wired link may be implemented with a power-line cable, coaxial cable, fiber-optic cable, or other cable or wires that support corresponding wired network technologies. For example, usage device 110 may utilize wired connections when at or near ground level, such as a wired connection between usage device 110 and operator device 120 for facilitating testing and/or calibration/setup. In other embodiments, the communication module 114 may send and/or receive information, including flight paths, signals associated with a location, media data, and/or restrictions/usage rights information or associated processes, over a cellular technology signal/network (e.g., 3G, 4G, 5G, and/or other 3GPP-based cellular network). Thus, usage device 110 may wirelessly communicate with other devices using wireless standards, such as the Institute of Electrical and Electronics Engineers (IEEE) 802.11 standard, Bluetooth® standard, ZigBee® standard, and/or other wireless standards; cellular standards, such as 3G, 4G, 4G LTE, 5G, and/or other cellular standards; infrared-based communication; optical-based communications; and/or other appropriate communication standards and/or protocols. In some cases, usage device 110 may be configured to communicate with another device using a proprietary wireless communication protocol and interface.

In certain embodiments, usage device 110 may include a payload unit that may be configured to implement features supported by usage device 110 and facilitate implementation of such features. The payload unit may include any equipment and associated logic, circuitry, interfaces, memory, and/or code. The payload unit may include a global positioning system (GPS) that provides a current position of usage device 110 (e.g., using three coordinates). The position information from the GPS, together with position information of devices in communication with usage device 110, may allow usage device 110 to execute a flight route as well as provide positioning information associated with a location. Depending on an application(s) of usage device 110, the payload unit may include one or more onboard sensors and/or data capture units, include a camera. By way of non-limiting example, sensors may include environmental sensors, such as temperature sensors, rain sensors, pressure sensors, humidity sensors, fog sensors, gas sensors, etc., or combination thereof; object/obstacle detection sensors, such as radar sensors, proximity sensors, motion detectors, etc., or combination thereof; imaging sensors (e.g., cameras); acoustic sensors, and/or other types of sensors, or combination thereof. Alternatively or in addition, the payload unit may include tools, actuators, robotic manipulators, etc., capable of performing an action, such as touching, grasping, delivering, and/or measuring objects. For delivery applications, the payload unit may include the object to be delivered, e.g. the object may be secured within a housing of usage device 110. The payload unit may be restricted in use by restriction on a location, and may require a usage right purchase by the user associated with usage device 110 to utilize without incurring a penalty.

Operator device 120 may be implemented as a communication device that may utilize appropriate hardware and software configured for wired and/or wireless communication with usage device 110, viewer device 150, and/or service provider server 160. For example, in one embodiment, operator device 120 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. Although only one device is shown, a plurality of devices may function similarly.

Operator device 120 of FIG. 1 contains a remote vehicle application 130, a transaction service application 140, input devices 112, other applications 114, a database 116, and a communication module 118. Remote vehicle application 130, transaction service application 140, and other applications 114 may correspond to executable processes, procedures, and/or applications with associated hardware. In other embodiments, operator device 120 may include additional or different modules having specialized hardware and/or software as required.

Remote vehicle application 130 may correspond to one or more processes to execute software modules and associated devices of operator device 120 to operate and utilize usage device 110 at (or nearby/within a proximity range to) a location, as well as receive information of usage restrictions and the location and request purchase of a usage right for use of usage device 110 at the location. In this regard, remote vehicle application 130 may correspond to specialized hardware and/or software utilized by a user of operator device 120 to communicate wirelessly (e.g., directly or via cellular standards using antennas) with the usage device 110. In an aspect, remote vehicle application 130 may be a remote control used by an operator (e.g., a human) to provide commands to usage device 110. For example, the operator may issue commands to instruct usage device 110 to fly in certain directions and/or at certain speeds and/or to perform activities such as picking up or delivering an object, capturing media data using a camera or other component, and/or performing another processes or functions.

Remote vehicle application 130 may include processes and interfaces to navigate usage device 110 and/or request use of usage device 110, which may include a map or location data for usage device 110, available processes and executable processes to use usage device 110, and/or other data for use of usage device 110. In this regard, remote vehicle application 130 may receive, from service provider server 160, notifications or alerts of restricted operations or use of usage device 110 and/or operator device 120 during use of said devices. Service provider server 160 may determine the restrictions based on the location of usage device 110 and/or operator device 120, as discussed herein, which may be provided to service provider server 160 during operation of usage device 110 and/or operator device 120 at a location. In other embodiments, different data may be provided to service provider server 160, such as captured media data or other data (e.g., received wireless signals) that may be used to identify a location of usage device 110 and/or operator device 120. Remote vehicle application 130 may further receive transaction information for a transaction to purchase or receive one or more permissions on use or a usage right to use usage device 110 and/or operator device 120 over the restriction for the location. Remote vehicle application 130 may include one or more graphical user interfaces (GUIs) to display notifications and alerts of usage restrictions for a location, where usage device 110 and/or operator device 120 is located at in relation to the location, and/or the available usage rights for use of usage device 110 and/or operator device 120 at the location. After display, through a GUI, of the usage rights, costs, purchasable items, and other transaction information to receive a usage right, remote vehicle application 130 may include one or more interfaces to enter a transaction request to purchase the usage rights, which may be processed using transaction service application 140.

In further embodiments, remote vehicle application 130 may further be used to request other types of transactions at a location, which may not be associated with a usage right. For example, remote vehicle application 130 may be used to request a transaction with a merchant or seller near a location. The transaction may be requested by identifying the merchant or the location using remote vehicle application 130, and transmitting the identification to service provider server 160. In further embodiments, the transaction may be initiated through data capture by usage device 110 and/or operator device 120, for example, an image of a merchant or a location that may be used to identify one or more merchants. The data may be transmitted to service provider server 160 for determination of transaction information. The transaction information may be displayed in one or more GUIs of remote vehicle application 130, where a transaction request may be initiated and processed using the GUIs with transaction service application 140. In certain embodiments, remote vehicle application 130 may further be used to display purchased data, such as media data, flight paths or travel routes, item pickup/delivery information, or other data after processing a transaction.

Transaction service application 140 may correspond to one or more processes to execute software modules and associated devices of operator device 120 to process a transaction based on transaction information received and displayed in remote vehicle application 130, and based on user input selecting a transaction for processing. In this regard, transaction service application 140 may correspond to specialized hardware and/or software to provide transaction processing services, for example, through one or more processes that provide an interface to permit the user to enter transaction input and other data. Transaction service application 140 may provide for a process to input one or more payment instruments, for example, through an input device (e.g., touch screen with a graphical user interface, keypad/keyboard, mouse, etc.) and/or through a data capture device (e.g., scanner, camera, other optical device, etc.) for use in establishing a payment account and/or processing a transaction. Such information may be stored with service provider server 160 for use with an online digital wallet stored to an account for the user with service provider server 160, which may be utilized for transaction processing with another entity, such as a controlling entity for a location that administers restrictions on device usage at the location and allows for purchase or receipt of usage rights for device usage at the location. In various embodiments, information for the account may also be stored to operator device 120 for use in an offline environment. The account accessible through transaction service application 140 may be used to initiate, receive, and/or process/complete transactions using services provided by service provider server 160. Once entered, the payment instruments may be communicated to service provider server 160 over network 180 by transaction service application 140 for establishment and/or maintenance/update of the account and/or entry into the digital wallet for the user. The user of operator device 120 may also enter discounts and/or benefits to transaction service application 140 for storage to the digital wallet and use during transaction processing.

Transaction service application 140 may utilize one or more user interfaces, such as GUIs presented using an output display device of operator device 120, to enable the user associated with operator device 120 to perform transaction processing within the restricted area. In various embodiments, transaction service application 140 may correspond to a general browser application configured to retrieve, present, and communicate information over the Internet (e.g., utilize resources on the World Wide Web) or a private network. For example, transaction service application 140 may provide a web browser, which may send and receive information over network 180, including retrieving website information (e.g., a website for service provider server 160), presenting the website information to the user, and/or communicating information to the website. However, in other embodiments, transaction service application 140 may include a dedicated application of service provider server 160 or other entity (e.g., a merchant), which may be configured to assist in processing transactions. The interface(s) providing by transaction service application 140 may be utilized to enter transaction information, receive transaction information from remote vehicle application 130 and/or service provider server 160, and/or initiate a process to communicate the preauthorized token to a device or server for processing with transaction information.

In this regard, transaction service application 140 may receive user input indicating a transaction to process directly and/or from remote vehicle application 130. The transaction request for processing may include items in the transaction, such as a usage right for a location, item from a merchant at the location, media content at the location, or additional purchase for the location (e.g., a flight path). Transaction service application 140 may be utilized to select payment instrument(s) for use in providing payment for the transaction. Additionally, transaction service application 140 may utilize a digital wallet stored to an account with a payment provider, such as service provider server 160, as the payment instrument, for example, through providing a token that identifies the account and authenticates the user for use of the account. Transaction service application 140 may be utilized to view the results of the transaction, for example, using transaction histories, dispute resolution processes, and other post-transaction process. Additionally, transaction service application 140 may display or provide data to remote vehicle application 130 based on processing the transaction, such as the usage right and right details (e.g., time remaining on the usage right, number of device uses, etc.), received item (e.g., media or flight path), and/or delivery/pickup information.

Although remote vehicle application 130 and transaction service application 140 are described as separate applications, in certain embodiments, one or more of their processes or features may be provided within the same application.

In this regard, input devices 112 may correspond to specialized hardware and/or software utilized by a user of operator device 120 that first receives, captures, and/or records video data, including media data that includes audio, visual, or audiovisual data captured by operator device 120. Thus, input devices 112 may utilize a camera or other optical/image data capturing device of input devices 112. Input devices 112 may instead correspond to a video recording application, where the video processing features to capture media data at a location. Input devices 112 may further receive media data processed by remote vehicle application 130. Input devices may be restricted in use based on restrictions at the location, and may require a usage restriction to operate without incurring a penalty. Input devices 112 may be associated with processes and/or applications of operator device 120 that receive or record media data and process the media data to output the data through one or more GUIs and display devices. In other embodiments, input device 110 may include other types of input sensors or devices that may be utilized at a location having location restrictions, and may require a usage right for use at the location based on the restrictions.

In various embodiments, operator device 120 includes other applications 114 as may be desired in particular embodiments to provide features to operator device 120. For example, other applications 114 may include security applications for implementing client-side security features, programmatic client applications for interfacing with appropriate application programming interfaces (APIs) over network 180, or other types of applications. Other applications 114 may also include email, texting, voice and IM applications that allow a user to send and receive emails, calls, texts, and other notifications through network 180. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for usage device 110 and/or operator device 120 and processes the location information to determine a location of usage device 110 and/or operator device 120 and the user. Other applications may include social networking applications, media viewing, and/or merchant applications. Other applications 114 may include device interface applications and other display modules that may receive input from the user and/or output information to the user. For example, other applications 114 may contain software programs, executable by a processor, including a graphical user interface (GUI) configured to provide an interface to the user. Other applications 114 may therefore use devices of operator device 120, such as display devices capable of displaying information to users and other output devices, including speakers.

Operator device 120 may further include database 116 stored to a transitory and/or non-transitory memory of operator device 120, which may store various applications and data and be utilized during execution of various modules of operator device 120. Thus, database 116 may include, for example, identifiers such as operating system registry entries, cookies associated with transaction service application 140 and/or other applications 114, identifiers associated with hardware of operator device 120, or other appropriate identifiers, such as identifiers used for payment/user/device authentication or identification, which may be communicated as identifying operator device 120 to service provider server 160. In various embodiments, account information and/or digital wallet information may be stored to database 116 for use by operator device 120. Database 116 may also store captured audio, video, or audiovisual content. Additionally, received usage rights and their associated parameters (e.g., length or number of uses) may be stored to database 116 for use by operator device 120 and proof of right to an administrating authority for a location (e.g., through display or transmission to another device using an application of operator device 120).

Operator device 120 includes at least one communication module 118 adapted to communicate with usage device 110, viewer device 150, and/or service provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices (e.g., viewer device 150) using short range communications, such as Bluetooth Low Energy, LTE Direct, WiFi, radio frequency, infrared, Bluetooth, and near field communications.

Viewer device 150 may be implemented using any appropriate hardware and software configured for wired and/or wireless communication with operator device 120 and/or service provider server 160. Thus, viewer device 150 may include one or more applications to view media data available from an online repository or resource, including service provider server 160, or directly from usage device 110/operator device 120 over network 180. In this regard, viewer device 150 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. Viewer device 150 may correspond to any device utilized for the presentation of media to a viewer, including devices having components and modules to process received media data and organize the media data to determine a medium used for presentation of the media to a user through one or more interfaces and output devices of viewer device 150. For example, a view device may include a mobile phone, tablet, or personal computing device described above that allows a view to access and view media content from one or more media content repositories. Viewer device 150 may further be used to process purchase of media data viewing rights from service provider server 160. Although only one merchant device is shown, a plurality of merchant devices may function similarly.

Viewer device 150 of FIG. 1 contains a media viewing application 152, other applications 154, a database 156, and a communication module 158. Media viewing application 152 and other applications 154 may correspond to processes, procedures, and/or applications executable by a hardware processor, for example, a software program. In other embodiments, viewer device 150 may include additional or different modules having specialized hardware and/or software as required.

Media viewing application 152 may correspond to one or more processes to execute modules and associated specialized hardware of viewer device 150 that provides an interface to access an online resource or marketplace to view media content, which may include downloading of past content, streaming of past or current content, and/or purchase of viewing rights to the content. In this regard, media viewing application 152 may correspond to specialized hardware and/or software of viewer device 150 to provide an interface to access the online resource, search the online resource for media content, and/or retrieve/view the media content. The viewing user may search for media content using one or more input fields of an interface of the marketplace. In certain embodiments, media viewing application 152 may search for media data for a location, which may correspond to a current location of the viewing user and/or viewer device 150 (e.g., determined through GPS coordinates or location entry). Once media is found, media viewing application 152 may request the media data, and may be used to view the media data. In certain embodiments, a payment may be required to view or stream the media data, which may be processed through electronic transaction processing provided by service provider server 160. Moreover, media viewing application 152 may also be used to provide donations or subscriptions to users and/or user uploads of media data from other users by the viewing user using viewer device 150.

Thus, media viewing application 152 may be used to establish a transaction once the viewing user has selected one or more media items for purchase. Once a payment amount is determined for the transaction for the item(s) to be purchased, media viewing application 152 may provide payment through electronic transaction processes, for example, processes similar to those discussed in reference to transaction service application 140 for a usage right. Media viewing application 152 may provide payment processing information to service provider server 160. Thus, payment may be provided to the appropriate account, and notification of payment (or failure, for example, where there are insufficient user funds) may be sent to media viewing application 152. Media viewing application 152 may then receive the results of the transaction processing, and complete the transaction, for example, by outputting the media content for viewing.

Viewer device 150 includes other applications 154 as may be desired in particular embodiments to provide features to viewer device 150. For example, other applications 154 may include security applications for implementing server-side security features, programmatic client applications for interfacing with appropriate application programming interfaces (APIs) over network 180, or other types of applications. Other applications 154 may also include email, texting, voice and IM applications that allow a user to send and receive emails, calls, texts, and other notifications through network 180. In various embodiments, other applications 154 may include financial applications, such as banking, online payments, money transfer, or other applications associated with service provider server 160. Other applications 154 may contain software programs, executable by a processor, including a graphical user interface (GUI) configured to provide an interface to the user.

Viewer device 150 may further include database 156 which may include, for example, identifiers such as operating system registry entries, cookies associated with media viewing application 152 and/or other applications 154, identifiers associated with hardware of viewer device 150, or other appropriate identifiers, such as identifiers used for payment/user/device authentication or identification. Identifiers in database 156 may be used by a payment/credit provider, such as service provider server 160, to associate viewer device 150 with a particular account maintained by the payment/credit provider. Downloaded and/or received media data may be stored to database 156, as well as subscriptions or other data allowing access to available media data.

Viewer device 150 includes at least one communication module 158 adapted to communicate with operator device 120 and/or service provider server 160. In various embodiments, communication module 158 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 160 may be maintained, for example, by an online service provider, which may provide location restriction services and transaction processing services for usage rights for one or more locations. In this regard, service provider server 160 includes one or more processing applications which may be configured to interact with usage device 110, operator device 120, viewer device 150, and/or another device/server to facilitate recommendation of items between users based on data captured by one of the user, as well as processing transactions for the items. In one example, service provider server 160 may be provided by PAYPAL®, Inc. of San Jose, Calif., USA. However, in other embodiments, service provider server 160 may be maintained by or include another type of service provider, which may provide connection services to a plurality of users.

Service provider server 160 of FIG. 1 includes a device operation marketplace 170, a transaction processor application 162, other applications 164, a database 166, and a network interface component 168. Device operation marketplace 170, transaction processor application 162, and other applications 164 may correspond to executable processes, procedures, and/or applications with associated hardware. In other embodiments, service provider server 160 may include additional or different modules having specialized hardware and/or software as required.

Device operation marketplace 170 may correspond to one or more processes to execute software modules and associated specialized hardware of service provider server 160 to determine a transaction at a location, which may correspond to required usage rights at the location and/or a transaction to purchase location specific items, and provide transaction information for the transaction to operator device 110 or other device for processing. In this regard, device operation marketplace 170 may correspond to specialized hardware and/or software to first receive, detect, or otherwise determine a location of a device. The location may be determined from received GPS coordinates or other data from a mapping or location detection system. In other embodiments, the location may be determined through received media data, such as an image or video, and associated image processing, such as object or geographic identification processes. After determination of the location device operation marketplace may access or determine restrictions on device usage at or nearby the location, which may include general use restrictions and/or restrictions on particular device, process, or application use (e.g., media capture, etc.). If the device or device use is limited or restricted at the location, device operation marketplace 170 may alert the user of operator device 110 of the restriction.

Device operation marketplace 170 may further determine available usage rights for the location based on the location and the restrictions. The usage rights or permissions may allow for general or limited use of a device at or near the location, to prevent penalization of the user based on the device usage at the location and the restriction. In this regard, the usage rights or permissions may be set based on the restrictions, and may include costs associated with the right. The right may be limited in time, numbers of use, and/or scope, which may further be set based on the cost for the specifically purchased right. Once the usage rights are determined, transaction information for one or more transactions for one or more of the rights may be generated, and communicated to operator device 120 for purchase. Operator device 120 may provide a response, such as a request to purchase the right, or may not wish to purchase the right. Where operator device 120 responds with a transaction processing request for the right, device operation marketplace 170 may process the transaction using transaction processor application 162. If the transaction processing is successful, device operation marketplace 170 may provide the usage right to the respective device, which may include authorizing the device with the controlling entity, allowing the device usage, and/or transmitting a digital credential or certification allowing device usage to the respective device (e.g., operator device 120), which may be digitally signed to provide authenticity and proof to a regulatory entity for the location. If operator device 120 does not purchase the right, no transaction may be processed. However, if usage device 110 or operator device 120 is utilized without the usage right at the location and violates one of the restrictions, device operation marketplace 170 may institute a penalty set for the barred device usage, which may be processed using an account of the user. In certain embodiments, the penalty may be automatically assessed and withdrawn from the user's account.

In various embodiments, device operation marketplace 170 may further be used as a media uploading, sharing, and/or streaming online service marketplace to provide media content captured for a location to one or more other users. For example, where a location is inaccessible and/or requires a usage right for media data capture, device operation marketplace 170 may be used as an online repository for users that capture data at the location to post or provide media content of the location for viewing and/or purchase by other users. Thus, device operation marketplace 170 may be accessed by usage device 110 and/or operator device 120 to upload captured media data. The upload may be associated with a usage right or permission for the location, which may be limited in time, number of uploads, or other scope. If the upload is barred by a restriction and/or does not have a usage right, device operation marketplace 170 may assess a penalty against the uploading device, as previously discussed, which may be automatically deducted from an account of the uploading user. Additionally, device operation marketplace 170 may remove the unauthorized content. However, if the content is authorized, the media content may be made available on the online marketplace, and one or more other devices may access and view the media content, such as viewer device 150. Additionally, the uploading user and/or service provider server 160 may determine a cost for viewing, downloading, sharing, or streaming, which may be assessed based on the viewing request, and processed using transaction processor application 162.

Transaction processor application 162 may correspond to one or more processes to execute software modules and associated specialized hardware of service provider server 160 to provide transaction processing services to one or more users, for example though an account and/or payment instruments of the users stored in a digital wallet of the account, in order to process transactions for location specific items including usage rights. In this regard, transaction processor application 162 may correspond to specialized hardware and/or software to establish one or more accounts, including digital wallets storing payment instruments. The services may allow for payments and/or transfers between the one or more users or merchants through a payment instrument, including a credit/debit card, banking account, payment account with service provider server 160, and/or other financial instrument. In order to establish an account for a user to send and receive payments, transaction processor application 162 may receive information requesting establishment of the payment account. The information may include user personal, business, and/or financial information. Additionally the information may include a login, account name, password, PIN, or other account creation information. The user may provide a name, address, social security number, or other personal or business information necessary to establish the account and/or effectuate payments through the account. Transaction processor application 162 may further allow the user to service and maintain the payment account, for example, by adding and removing payment instruments.

Transaction processor application 162 may be used to provide a payment for a transaction, for example, where a user wishes to purchase and receive usage right for a location to utilize a device over restrictions on device usage at the location, or where the user wishes to purchase other location specific items. Thus, when the user for communication device 110 wishes to process a payment or transfer with the controlling entity for the location and/or another merchant or seller for the location, communication device 110 may provide a stored token or other required information (e.g., an identifier) to a device/server for the entity and/or service provider server 160 for identification of the user's account, as well as transaction information including the transaction amount, purchased items, etc. The transaction request may identify the account of the entity, for example, using the contact information. Transaction processor application 162 may then process the transaction using the received transaction information. Transaction processor application 162 may utilize data in the transaction information to debit an account of the appropriate user and provide the payment to an account of the other user, merchant, or seller associated with the restricted location. Transaction processor application 162 may also be used to provide transaction histories for processed transactions.

In various embodiments, service provider server 160 includes other applications 164 as may be desired in particular embodiments to provide features to service provider server 160. For example, other applications 164 may include security applications for implementing server-side security features, programmatic client applications for interfacing with appropriate application programming interfaces (APIs) over network 180, or other types of applications. Other applications 164 may contain software programs, executable by a processor, including a graphical user interface (GUI), configured to provide an interface to the user when accessing service provider server 160, where the user or other users may interact with the GUI to more easily view and communicate information. In various embodiments, other applications 164 may include connection and/or communication applications, which may be utilized to communicate information to over network 180.

Additionally, service provider server 160 includes database 166. As previously discussed, the user and/or the merchant may establish one or more digital wallets and/or accounts with service provider server 160. Digital wallets and/or accounts in database 166 may include user information, such as name, address, birthdate, payment instruments/funding sources, additional user financial information, user preferences, and/or other desired user data. Users may link to their respective digital wallets and/or payment accounts through an account, user, merchant, and/or device identifier. Thus, when an identifier is transmitted to service provider server 160, e.g., from operator device 120, one or more digital wallets and/or payment accounts belonging to the users may be found. Database 166 may store received usage restrictions, and associated usage rights, costs, and penalties, for a location, which may be established by a controlling entity for the location. Additional information for service provider server, including location specific purchases, uploaded media, and other data may also be stored to database 166.

In various embodiments, service provider server 160 includes at least one network interface component 168 adapted to communicate usage device 110, operator device 120, and/or viewer device 150 over network 180. In various embodiments, network interface component 168 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 180 may be implemented as a single network or a combination of multiple networks. For example, in various embodiments, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of system 100.

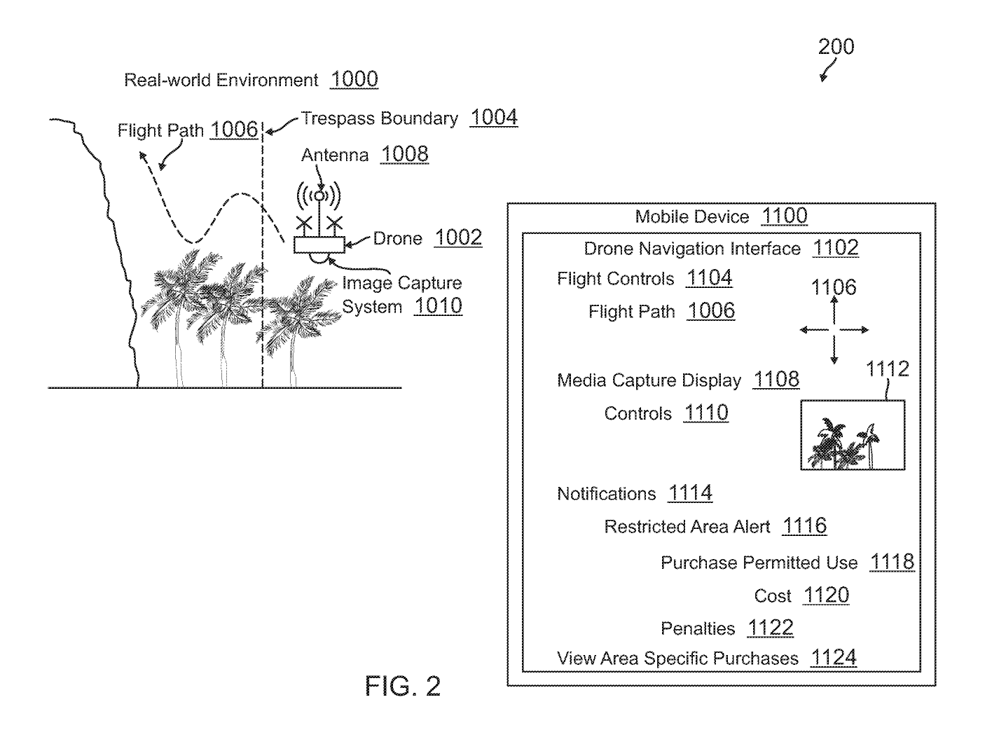

FIG. 2 is an exemplary environment 200 having an unmanned vehicle operating in a location having usage restrictions and a mobile device to enable restricted device usage at the location, according to an embodiment. Environment 200 of FIG. 2 includes a drone 1002 that may correspond to a portion or all of the described processes herein discussed in reference to usage device 110 in system 100 of FIG. 1. Environment 200 of FIG. 2 further includes a mobile device 1100 that may correspond to a portion or all of the described processes herein discussed in reference to operator device 120 in system 100 of FIG. 1.

A user (not shown) may utilize mobile device 1100 to control drone 1002 within a real-world environment 1000. Real-world environment 1000 may correspond to a real-world location where users may operate devices, such as drone 1002 flying through real-world environment 1000. However, a controlling entity for real-world environment 1000 may establish restrictions on device usage at or around the location in real-world environment 1000. The restrictions may be implemented on devices crossing trespass boundary 1004, so that devices within the location designated by trespass boundary 1004 may be restricted in device usage, and may require a usage right to operate or perform specific actions or processes. Such actions and/or processes may include flight of drone 1002 at the location demarcated by trespass boundary 1004, landing within the location, releasing/retrieving items within location, and/or media capture by drone 1002. In this regard, control of drone 1002 may be performed through radio signals sent and received from antenna 1008 to mobile device 1100, which may designate a flight path 1006 that travels over trespass boundary 1004 and therefore may be restricted. A location of drone 1002 may be determined by drone 1002 and transmitted using antenna 1008 to mobile device 1100, or may be determined through other information including control signals for drone 1002 sent and received using antenna 1008. Additionally, drone 1002 may operate image capture system 1010 to capture media data, which may be transmitted to mobile device 1100. In certain embodiments, the media data may be used to determine a location of the drone, as well as identifications in real-world environment 1000, such as information necessary to determine trespass boundary 1004 and local restrictions, and/or other merchants and seller within real-world environment 1000.

Mobile device 1100 may therefore include a drone navigation interface 1102 used to control drone 1002 and display any restrictions on usage of drone 1002 within the location designated by trespass boundary 1004. Drone navigation interface 1102 includes flight controls 1104 and directional controls 1106, as well as a flight path 1006 that crosses trespass boundary 1004 and therefore causes drone 1002 to be restricted within real-world environment 1000. The restriction may be for flight of drone on flight path 1006, as well as for media capture of media using image capture system 1010, for example, a media capture display 1108 of drone navigation interface 1102 may include controls 1110 of image capture system 1010 that may be used to capture media data 1112. One or more of flight controls 1104 and controls 1110 for media capture display 1108 may be limited by a restriction, which may be enforced on operations of flight controls 1104 and controls 1110.

Thus, notifications 1114 of drone navigation interface 1102 may be populated with information of a restriction on flight controls 1104 and/or controls 1110 for media capture display 1108 based on crossing trespass boundary 1004. Notifications 1114 may include a restricted area alert 1116 based on drone 1002 crossing trespass boundary 1004 on flight path 1006. Restricted area alert 1116 may therefore be generated based on a determined location of drone 1002, for example, using a location detected by a GPS or other location detection component of drone 1002 and transmitted using antenna 1008, or through media data captured using image capture system 1010 and subsequent image recognition to determine a location of the media. Restricted area alert 1116 may be determined by a service provider or controlling entity establishing a restriction on real-world environment 1000 that corresponds to the location demarcated by trespass boundary 1004. Restricted area alert 1116 may be associated with a usage right or permission to use drone 1002 on flight path 1006, including flight of drone 1002 and/or media capture by drone 1002 using image capture system 1010. In certain embodiments, restricted area alert 1116 may include code and/or processes to limit flight controls 1104 and/or controls 1110 for media capture display 1108, or may detect restricted use of flight controls 1104 and controls 1110 for media capture display 1108 when determining whether to assess a penalty on operation of drone 1002

Thus, restricted area alert 1116 may include an option to purchase permitted use 1118, which may initiate a process to receive the usage right or permission. The usage right or permission may have an associated cost 1120 displayed in restricted area alert 1116. Additionally, the user may view penalties 1122 on use without the usage right in restricted area alert 1116. In certain embodiments, notification 1114 may also include area specific purchases, such as other media for the area, operations for drone 1002 (e.g., flight paths, locations for media capture, etc.), and/or available merchants or sellers at a location. View area specific purchases 1124 may include an option to view such purchases. The user may select one or more of purchase permitted use 1118 and view area specific purchases 1124 to initiate an application process to view and purchase the associated item, which may include processing with a service provider.

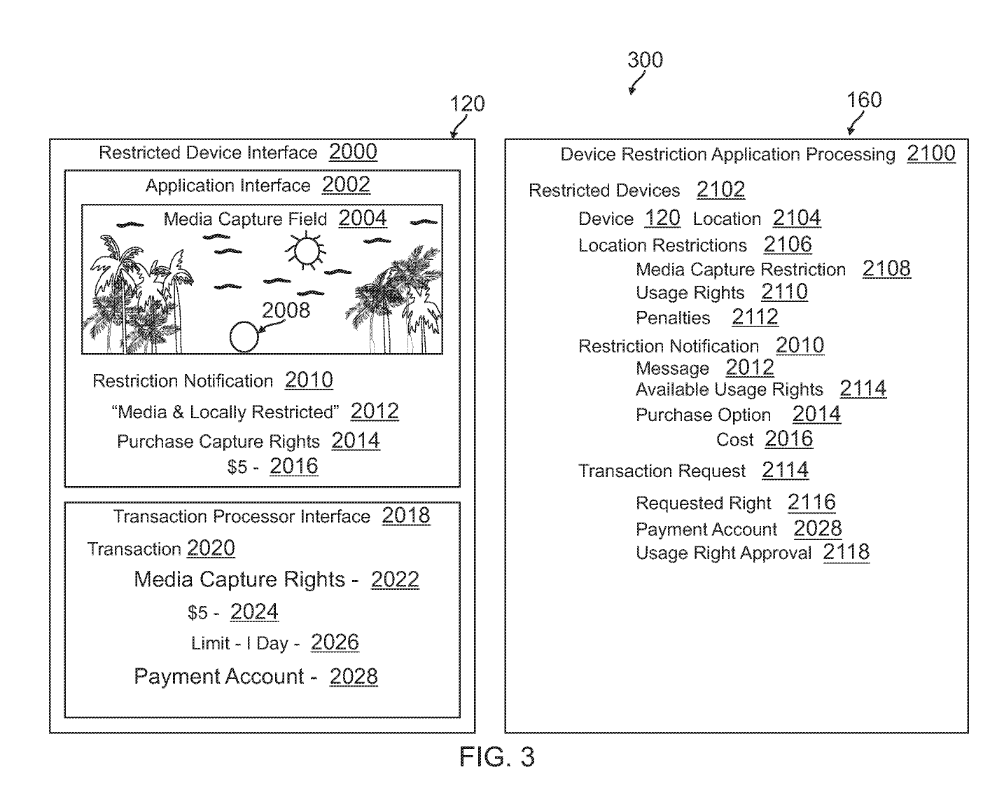

FIG. 3 is an exemplary system environment showing a communication device and a service provider server interacting to provide an online transaction processor to enable location-based restricted device usage, according to an embodiment. FIG. 3 includes operator device 120 and service provider server 160 discussed in reference to system 100 of FIG. 1. Operator device 120 and service provider server 160 may display one or more interfaces and/or execute one or more operations as discussed by the components, processes, and features of operator device 120 and service provider server 160 discussed in reference to system 100 of FIG. 1.

Operator device 120 includes restricted device interface 2000 having an application interface 2002 that may display output for one or more of the processes or features discussed in reference to the applications of operator device 120 in system 100 of FIG. 1. In this regard, application interface 2002 includes data for one or more processes that may be restricted based on a location of operator device 120. The restrictions may be one device usage of operator device 120, and may include associated usage rights that may be purchased to provide permission for device usage over the restrictions. Media capture field 2004 may include media data for capture by operator device 120, for example, by selecting a capture button 2008 to capture displayed media data. However, during operation of operator device 120 at the location, one or more processes executable by operator device 120 may be limited by restrictions at the location, including media capture using capture button 2008.

Thus, based on the location of operator device 120, a restriction notification 2010 may be determined by service provider server 160, as discussed herein. Restriction notification may include a message 2012 that displays “Media is Locally Restricted” to inform the user of the restriction on media capture using capture button 2008. Restriction notification 2010 may include a purchase option 2014 that allows for the user to capture media data, as well as a cost of $5 in order to receive the usage right to capture media data. In further embodiments, restriction notification 2010 may include multiple purchasable usage rights, as well as associated costs for each right, including level, amount, or length of the particular usage right. If the user wishes to purchase a usage right, for example, by selecting purchase option 2014, transaction processor interface 2018 may be utilized to process and complete the transaction for the selected usage right. Transaction processor interface 2018 may include a transaction 2020 for media capture rights 2022. A purchase cost 2024 may populate for cost 2016 as well as any further requested payment for additional items. Usage right parameter 2026 may also be displayed for transaction 2020, which show a limit of 1 day for media capture rights 2022. Additionally, the user may designate a payment instrument used for transaction processing of transaction 2020, such as a payment account 2028.

Service provider server 160 includes device restriction application processing 2100 that may process data to determine location-based device usage restrictions associated with the processes and features discussed in reference to system 100 of FIG. 1. In this regard, device restriction application processing 2100 includes data for restricted device 2102 to determine restrictions, and generate notifications of the restrictions and/or associated usage rights available for the restrictions. For example, restricted device 2102 may include data for operator device 120 location 2104 used to determine location restrictions 2106. Location restrictions 2016 may be for a specific location, such as one established by a controlling entity for the location. Location restrictions 2106 may include a media capture restriction 2108 on operator device 120, which may limit use of capture button 2008 and/or cause penalties 2112 to the user on use of capture button 2008 if/when detected. Moreover, media capture restriction 2108 may be associated with usage rights 2110 to allow use over media capture restriction 2108, which may each have associated costs and right parameters.

Based on operator device 120 location 2104 and location restrictions 2106, restriction notification 2010 may be determined, which is communicated to operator device 120. Restriction notification 2010 includes message 2012 for the available usage rights 2114, as well as the purchase option 2014 and cost 2016. In response to restriction notification 2010, device restriction application processing 2100 may receive a transaction request 2114 for processing, which may include a requested right 2116. Transaction request 2114 may be transmitted by operator device 120 to purchase request right 2116 for operator device 120, and may include the designated payment account 2028 for transaction processing. Based on the results of the transaction processing, a usage right approval 2118 may be generated, which may be transmitted to operator device 120 for storage and/or unlocking of the associated device usage, or to the controlling entity of the location.

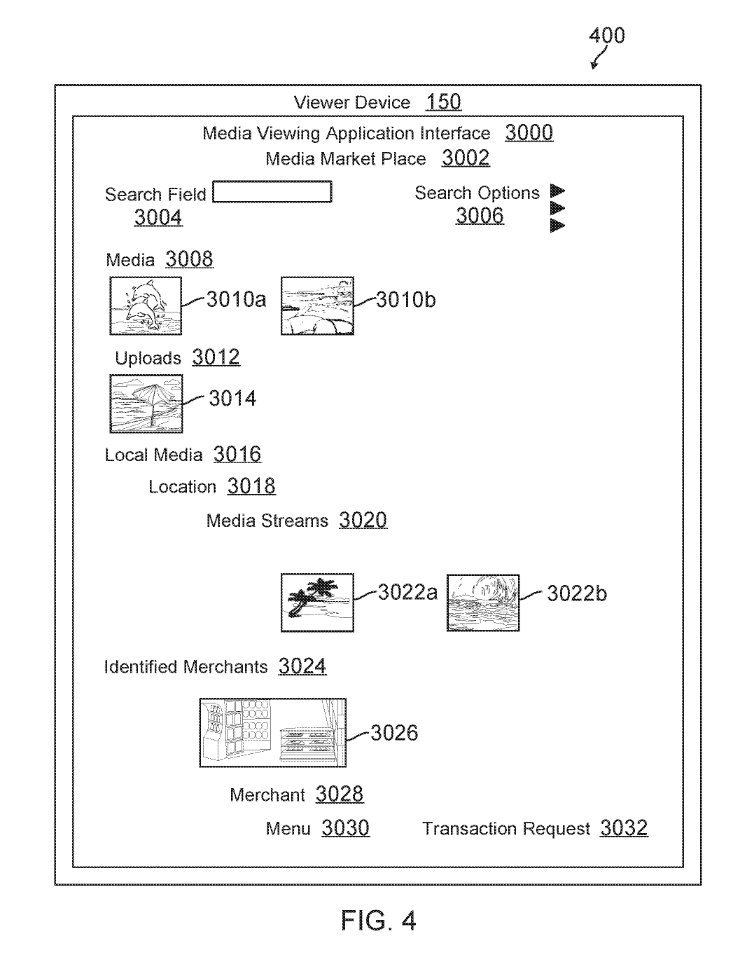

FIG. 4 is an exemplary interface of a communication device used to view available media content captured for locations and process transactions with merchants identified at a location, according to an embodiment. Environment 400 of FIG. 4 includes viewer device 150 discussed in reference to system 100 of FIG. 1.

In this regard, media viewing application interface 3000 includes a media marketplace 2003 where a user may view uploaded media data, upload media data, and/or utilize media data to process one or more transactions for a merchant or seller identified in the media data. For example, a search field 3004 and search options 3006 may be used to search for available uploaded media data for a location, where the location may have restrictions on device usage at the location making media data capture difficult or inaccessible to other users. Searched media data may include media 3008, which may have media file 3010a and media file 3010b for viewing. Media files 3010a-b may require a payment for viewing, streaming, and/or downloading, and may be associated with past uploaded content by other users or live streaming content. Thus, a user viewing media 3008 may be required to process a transaction to view media files 3010a-b.

A user may also provide uploads 3012 to media marketplace 3002 based on media content and other data captured by the user's device. Rights to upload a media upload 3014 may be required to be purchased by the user when purchasing a usage right to a location. Moreover, once uploaded, media upload 3014 may be viewed by other users. The user uploading media upload 3014 may set the cost for viewing by other users, or may allow media marketplace to determine a cost. Thus, the user providing media upload 3014 may be compensated by media marketplace 3002 and/or other users based on views of media upload 3014.

In various embodiments, media marketplace 3002 may include local media 3016 that may correspond to uploaded media data that is local to a location 3018 currently identified for a user. The location 3018 may have device usage restrictions, which may restrict media capture so that local media 3016 may be of interest to the user. However, in other embodiments, local media 3016 may show points of interest, geographic landmarks, or other media data that may be of interest to the user. Local media 3016 includes media streams 3020 of media content that is associated with location 3018, which may include a stream 3022a and a stream 3022b. Streams 3022a-b may include currently captured media data at the time that the user is at location 3018. However, in other embodiments, streams 3022a-b may include previously captured and uploaded media data. Similar to above, streams 3022a-b may be free to access, or may include a corresponding cost.

Moreover, a user may also upload media data to media marketplace 3002 for determination of a merchant in or local to the uploaded data. For example, identified merchants 3024 may be determined using merchant media data 3026, which may correspond to an image or video of the merchant and/or geographic landmarks or images at or around the merchant for identification of the merchant. Merchant media data 3026 may therefore be processed using image recognition, and the merchant may be identified. Based on identification of the merchant, a menu 3030 of available items may be determined and transmitted to a device of a user requesting a transaction with the merchant. In response, a transaction request 3032 may be received and processed by the server associated with media marketplace 3002.

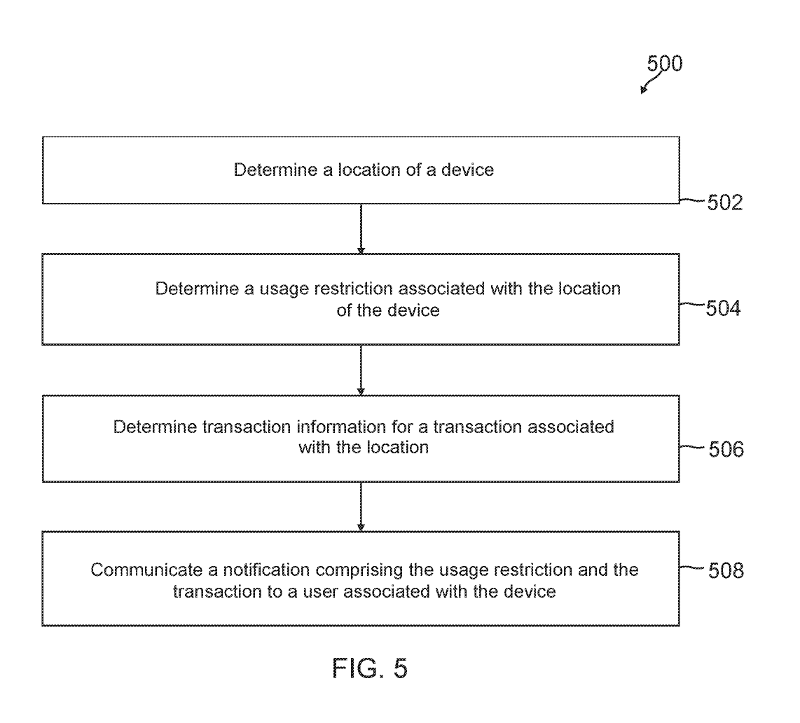

FIG. 5 is a flowchart of an exemplary process 500 for an online transaction processor to enable location-based restricted device usage, according to an embodiment. Note that one or more steps, processes, and methods described herein may be omitted, performed in a different sequence, or combined as desired or appropriate.

At step 502, a location of a device, such as a mobile device or unmanned vehicle is determined. The location may be determined through one of a GPS of the unmanned vehicle, a navigation system of a device operating the unmanned vehicle, a camera of the unmanned vehicle, or a radio signal emitted by the unmanned vehicle or received by the unmanned vehicle

A usage restriction associated with the location of the device is determined, at step 504. At step 506, transaction information for a transaction to receive usage rights associated with the usage restriction of the device is determined. Where the device corresponds to an unmanned vehicle, the unmanned vehicle may comprise an unmanned aerial vehicle. The usage rights comprise at least one of flight rights to fly the unmanned aerial vehicle at the location or data capture rights to capture media data using the unmanned aerial vehicle at the location. The transaction information may comprise costs for the usage rights of the unmanned vehicle at the location, including at least one price for at least one of flight duration, flight path, image capture, video capture, or uploading and sharing of the media data. In certain embodiments, the transaction information further comprises flight paths purchasable for the unmanned aerial vehicle at the location.

At step 508, an alert comprising the usage restriction and the transaction is communicated to a user associated with the device. In various embodiments, a transaction processing request for the transaction may be received, and the transaction may be processed in accordance with the transaction processing request, for example, by purchasing the usage right. In other embodiments, the user may request the transaction is not processed and no usage right is purchased. In such embodiments, the usage rights provide permission for use of the unmanned vehicle at the location, and the usage restriction is associated with a penalty on use of the unmanned vehicle at the location without the usage rights. The alert or notification for the user may further include information for the penalty for viewing by the user. Where the transaction processing request does not purchase the usage rights, it may be determined that the unmanned vehicle operated at the location without the usage rights for the usage restriction, and a payment for the penalty on use of the unmanned vehicle at the location may be assessed on the user and processed. The user may also request to purchase media data capture rights over the area of the location, and, in response to processing the request, the device may be authorized for the media data capture rights at the location.

In certain embodiments, media data may be received from the device, and the media data may be provided on an online marketplace for viewing by other users. The online marketplace may provide media streaming services for the media data to the other users, which may include purchase options for viewing of the media data on the online marketplace. In such embodiments, a location of one of the other users may be received, and available media data captured for the location on the online marketplace may be transmitted to the other user. The marketplace may further be used to provide travel paths for unmanned vehicles at the location, for example, by determining a travel path taken by unmanned vehicle at the location and providing the travel path for purchase by the other users on the online marketplace.

In certain embodiments, prior to determining the location of the unmanned vehicle, a request to order from a merchant associated with the location may be determined, the merchant may be determined, and the transaction information may include items available from the merchant. Thus, the transaction request may instead be a purchase request for one or more of the items using an account of the user with the service provider. In order to determine the location and/or the merchant, media data from a media capture component of the device or unmanned vehicle may be received, and at least one of the merchant or the location is determined through image analysis, object recognition, metadata, or other data or data processing technique used on the media data. Delivery instructions for the one or more items in the purchase request may be received from the user's device and communicated to the merchant. In various embodiments, the device may instead comprise a drone device managed by a different entity from the user that is authorized for use at the location. Thus, the transaction request may comprise a request to operate the drone device by the user.

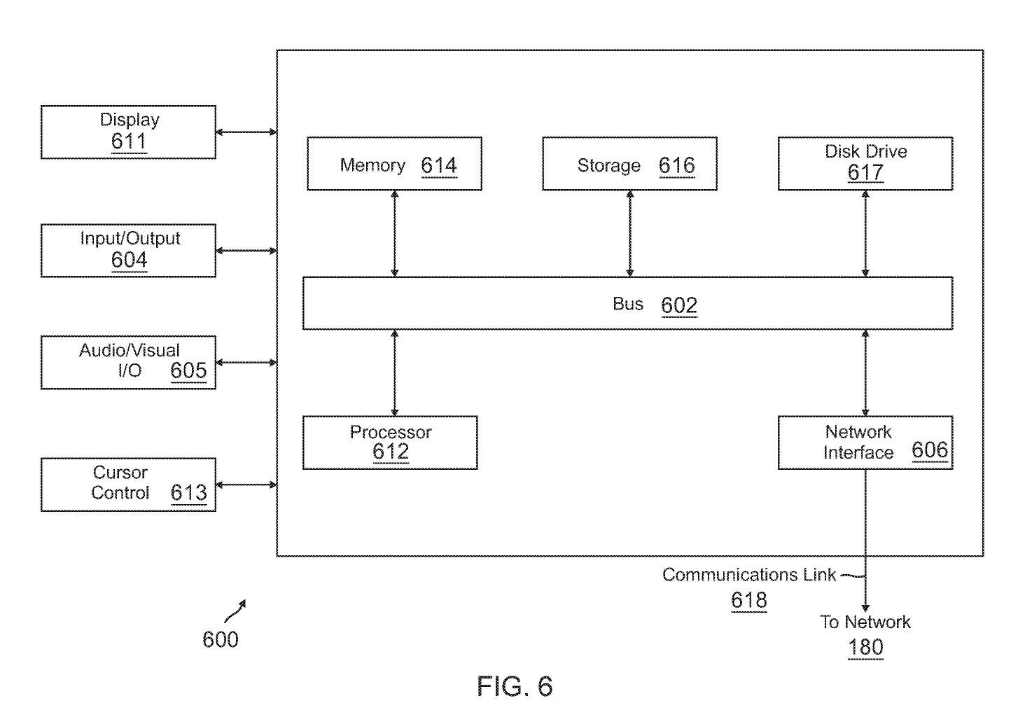

FIG. 6 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. A transceiver or network interface 606 transmits and receives signals between computer system 600 and other devices, such as another communication device, service device, or a service provider server via network 180. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a non-transitory memory; and
one or more hardware processors coupled to the non-transitory memory and configured to read instructions from the non-transitory memory to cause the system to perform operations comprising:
determining a location of an unmanned vehicle;
determining, based on the location, a usage restriction associated a geo-fenced area;
determining, based on the location, that the unmanned vehicle is within a proximity of the geo-fenced area;
communicating an alert comprising the usage restriction and a usage right for usage restriction associated with the geo-fenced area to a user associated with the unmanned vehicle;
receiving a transaction processing request for a transaction for the usage right from the user; and
processing the transaction in accordance with the transaction processing request.

2. The system of claim 1, wherein the unmanned vehicle comprises an unmanned aerial vehicle, and wherein the usage right comprise at least one of flight rights to fly the unmanned aerial vehicle in the geo-fenced area or data capture rights to capture media data within the geo-fenced area using the unmanned aerial vehicle.

3. The system of claim 2, wherein the transaction further comprises a flight path purchasable for the unmanned aerial vehicle through the geo-fenced area.

4. The system of claim 2, wherein the usage right comprises a cost for the usage right, and wherein the cost includes at least one price for at least one of flight duration, flight path, image capture, video capture, or uploading and sharing of the media data.

5. The system of claim 1, wherein the usage right provides permission for use of the unmanned vehicle at the geo-fenced area, wherein the usage restriction is associated with a penalty on use of the unmanned vehicle at the geo-fenced area without the usage right, and wherein the alert further includes the penalty.

6. The system of claim 5, wherein the transaction processing request does not include a purchase the usage right in the transaction, and wherein the operations further comprise:
determining that the unmanned vehicle operated at the geo-fenced area without the usage right for the usage restriction; and
processing a payment for the penalty on use of the unmanned vehicle at the geo-fenced area.

7. The system of claim 1, wherein the usage restriction is set for the geo-fenced area by an entity that controls device use at the geo-fenced area, wherein the usage right comprises a permission by the entity to utilize the vehicle at the geo-fenced area, and wherein the transaction includes purchase of the peimission.

8. The system of claim 1, wherein the operations further comprises:
receiving media data from the unmanned vehicle; and
providing the media data on an online marketplace for viewing by other users.

9. The system of claim 8, wherein the online marketplace provides media streaming services for the media data to the other users, and wherein the media streaming services include purchase options for viewing of the media data on the online marketplace.

10. The system of claim 9, wherein the operations further comprise:
receiving a location of one of the other users; and
communicating information comprising available media data captured within the geo-fenced area on the online marketplace.

11. The system of claim 8, further comprising:
determining a travel path taken by unmanned vehicle through the geo-fenced area; and
providing the travel path for purchase by the other users on the online marketplace.

12. The system of claim 1, wherein the location is determined through one of a GPS of the unmanned vehicle, a navigation system of a device operating the unmanned vehicle, a camera of the unmanned vehicle, or a radio signal emitted by the unmanned vehicle or received by the unmanned vehicle.

13. A method comprising:
determining a location of an unmanned vehicle;
determining transaction information associated with the location;
communicating the transaction information to a user associated with the unmanned vehicle;
receiving, by a service provider, a transaction request associated with the transaction information from the user; and
processing, by the service provider, the transaction request.

14. The method of claim 13, wherein prior to the determining the location of the unmanned vehicle, the method further comprises:
receiving a request to order from a merchant associated with the location;
determining the merchant associated with the location,
wherein the transaction information comprises items available from the merchant, and wherein the transaction request comprises a purchase request for one or more of the items using an account of the user with the service provider.

15. The method of claim 14, wherein prior to determining the location of the unmanned vehicle, the method further comprises:
receiving media data from a media capture component of the unmanned vehicle,
wherein at least one of the merchant or the location is determined using the media data.

16. The method of claim 14, further comprising:
receiving delivery instructions for the one or more items in the purchase request; and
communicating, to the merchant, the delivery instructions with a transaction history for the processing the transaction request.

17. A non-transitory machine-readable medium having stored thereon machine-readable instructions executable to cause a machine to perform operations comprising:
in response to receiving a transaction request for use of a device at a location, determining a transaction for use of the device at the location;
generating a notification for the transaction;
communicating the notification to a user associated with the device; and
in response to receiving a response to the notification, processing the transaction according to the request.

18. The non-transitory machine-readable medium method of claim 17, wherein the transaction request comprises one of a first request for permission to operate the device at the location or a second request for permission to capture media data at the location.

19. The non-transitory machine-readable medium of claim 17, wherein the location is associated with restriction on use of devices at location, wherein the device comprises a drone device managed by a different entity from the user that is authorized for use at the location, and wherein the transaction request comprises a request to operate the drone device by the user.

20. The non-transitory machine-readable medium of claim 17, wherein the transaction request comprises a request to purchase media data capture rights over the area of the location, wherein the response comprises a purchase request for the media data capture rights, and wherein the operations further comprise:
processing the purchase request; and
authorizing the device for the media data capture rights at the location.
